(19) United States
(12) Patent Application Publication
(10) Pub. No.: US 2012/0163935 A1
(43) Pub. Date: Jun. 28, 2012

(54) MACHINE FOR MAKING GEARS

(76) Inventors: Artemio Affaticati, Busto Arsizio (IT); Francischet Marco, Mirano (IT); Manara Mauro, Argenta (IT); Perrone Vito, Crema (IT)

(21) Appl. No.: 13/377,350

(22) PCT Filed: Jun. 9, 2010
(86) PCT No.: PCT/IB2010/001381

§ 371 Date: Mar. 19, 2012

(30) Foreign Application Priority Data
Jun. 9, 2009 (IT) BO2009A000373

(51) Int. Cl. B23F 17/00; B23Q 1/28

(52) U.S. Cl. 409/6

(57) ABSTRACT

A machine for making gears is provided with at least one faceplate, which supports a piece during machining and is movable in a given forward direction, at least one operating head, that supports at least one tool for machining the piece, and is movable in the forward direction, and a first and a second locking device to selectively lock the operating head and the faceplate in the forward direction respectively.

### TECHNICAL FIELD

The present invention relates to a machine for making gears.

### BACKGROUND ART

In the gear manufacturing field, a known method of making gears consists of machining a set of teeth on a corresponding piece and subsequently grinding the toothed piece. Each gear cutting and grinding process comprises a respective rough-machining phase and a respective finishing phase of the piece.

Generally, the gear cutting process is performed by a gear cutting machine that comprises a faceplate mounted so as to rotate about its own longitudinal axis and a machining head, which is provided with at least one tool for machining the piece, and is movable along a guiding device extending in a direction substantially transversal to the longitudinal axis of the faceplate.

Since the high level of stress transmitted to the operating head and, thus, to said guiding mechanism during the gear cutting process may affect the correct orientation and correct shape of said guiding mechanism, the prior art gear cutting machines of the type described above, although extremely well tried and tested, are unable to perform the subsequent grinding phase which, unlike the initial gear cutting process, requires high precision and tolerances.

Consequently, once the gear cutting process is complete, the piece must be transferred to a grinder that is structurally similar to the gear cutting machine, which therefore makes the gear production process relatively complex and expensive.

### DISCLOSURE OF INVENTION

It is an object of the present invention to provide a machine for making gears that has none of the disadvantages described above and is simple and economic to manufacture.

According to the present invention, there is provided a machine for making gears, as disclosed in the attached claims.

### BRIEF DESCRIPTION OF THE DRAWINGS

The present invention will now be described with reference to the attached drawings which illustrate a non-limiting embodiment thereof, in which:

FIG. 1 is a schematic perspective view of a preferred embodiment of the machine according to the present invention;

FIG. 2 is a plan view of the machine in FIG. 1;

FIG. 3 is a schematic side view, with sections of parts, parts removed, and parts enlarged for the sake of clarity, of a first detail of the machine in FIGS. 1 and 2;

FIG. 4 is a schematic side view, with sections of parts and parts removed for the sake of clarity, of a second detail of the machine of FIGS. 1 and 2; and

FIG. 5 is a schematic side view, with sections of parts and parts removed for the sake of clarity, of a detail of FIG. 4.

### BEST MODE FOR CARRYING OUT THE INVENTION

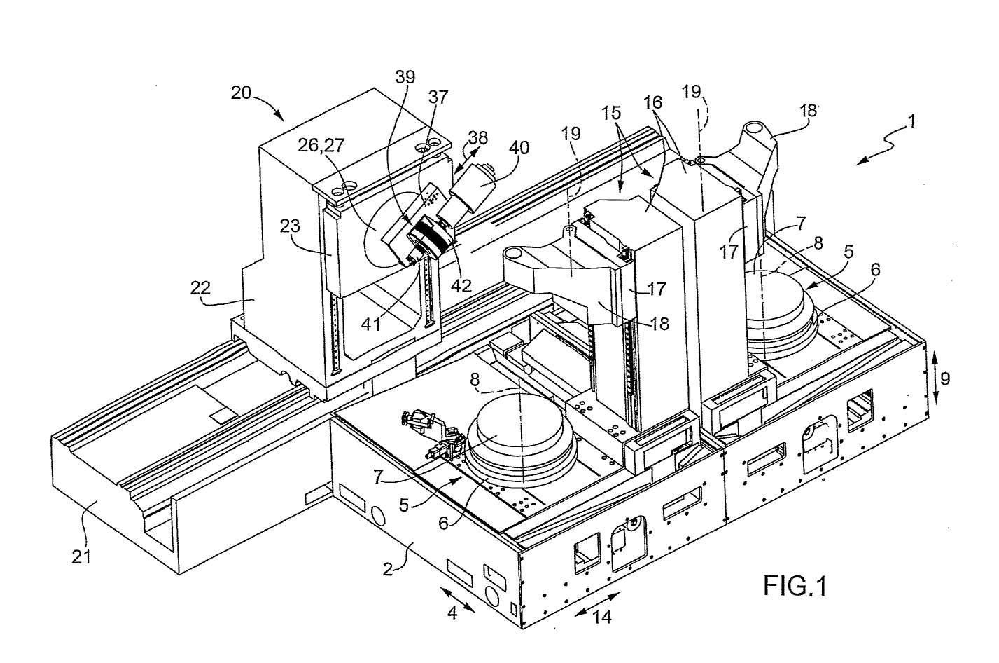

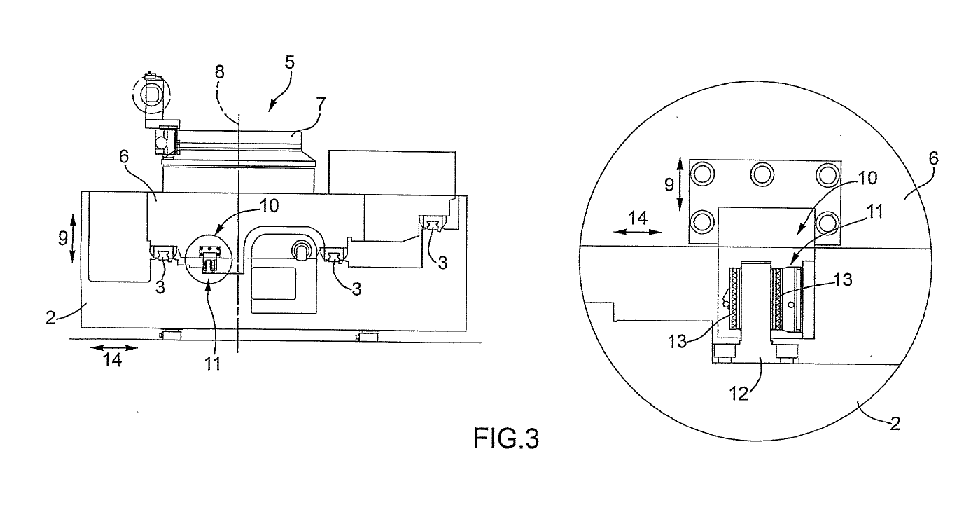

With reference to FIGS. 1 and 3, number 1 indicates, as a whole, a machine for making gears (not shown) comprising a support frame 2, which is substantially rectangular in shape, and supports two guiding devices 3 that are parallel to each other and to a substantially horizontal direction 4.

Each device 3 is slidingly engaged by a relative clamping unit 5 comprising a slide 6, which is slidingly coupled to the device 3 so as to move, with respect to the frame 2 and under the thrust of a known and not shown actuating device, in a straight line in the direction 4, and supports a faceplate 7, which is suitable to support a substantially cylindrical workpiece (not shown) and is mounted on the slide 6 so as to rotate, with respect to the slide 6 and under the thrust of a known and not shown actuating device, about its own longitudinal axis 8 parallel to a substantially vertical direction 9 and transversal to the direction 4.

According to FIG. 3, each slide 6 is suitable to be locked along the relative device 3 by a locking device 10 comprising a brake 11, which in turn comprises a crosspiece 12 mounted on the frame 2 parallel to the direction 4 and two braking shoes 13 which are housed inside the slide 6, extend in the direction 4, are arranged on opposite sides of the crosspiece 12 in a horizontal direction 14 orthogonal to the directions 4 and 9, and are movable, driven by a hydraulic actuator (not shown) obtained at least in part through the slide 6, between a clamping position and a released position of said crosspiece 12.

With reference to FIG. 1, each unit 5 cooperates with an operating unit 15 comprising a vertical column 16, which extends upwards from the frame 2 in the direction 9, is arranged between the two units 5 facing the column 16 of the other unit 15, and supports a slide 17 slidingly coupled to the column 16 so as to move in a straight line in the direction 9 along the column 16 under the thrust of a known and not shown actuating device.

The unit 15 also comprises a support arm 18, which is hinged to the slide 17 to rotate, with respect to the slide 17 and under the thrust of a known and not shown actuating device, about a fulcrum axis 19 parallel to the direction 9, and supports an auxiliary device (not shown) for machining and/or controlling the piece (not shown) mounted on the relative faceplate 7.

The machine 1 is also provided with an additional operating unit 20 comprising an elongated base 21, which extends in the direction 14, is arranged alongside the frame 2, and one end of which protrudes from said frame 2; a horizontal slide 22, which extends upwards from the base 21 in the direction 9, and is slidingly coupled to the base 21 so as to move in a straight line along the base 21 in the direction 14 under the thrust of a known and not shown actuating device; and a vertical slide 23 slidingly coupled to the slide 22 so as to move in a straight line along the slide 22 in the direction 9 under the thrust of a known and not shown actuating device.

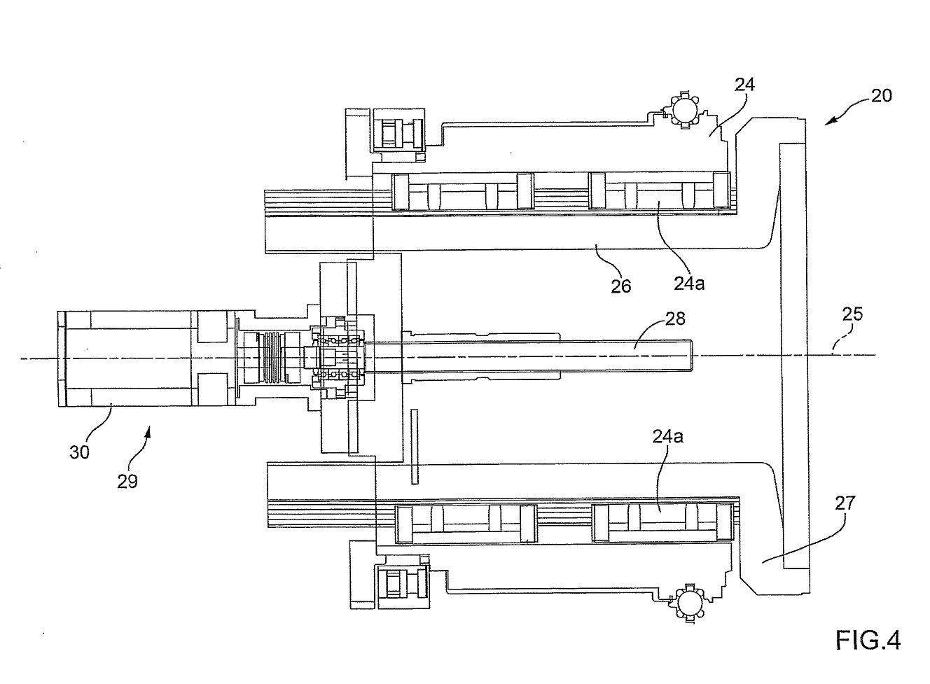

According to FIG. 4, the slide 23 is rotatingly engaged by a tube 24, which has a longitudinal axis 25 parallel to the direction 4, extends through the slide 23, and is mounted to rotate with respect to the slide 23 about said axis 25 under the thrust of a known and not shown actuating device.

The tube 24 supports a tubular slide 26, which extends inside the tube 24, coaxially with respect to the axis 25, is axially limited by an annular flange 27 that extends outside and facing the tube 24, is slidingly coupled to a pair of guideways 24a mounted on the inner surface of the tube 24, parallel to the direction 4, and is also coupled, by means of a lead screw system, to a screw 28 of an actuating device 29, one motor 30 of which fixed to the tube 24 makes the screw 28 rotate to make the slide 26 move in a straight line along said tube 24 in the direction 4.

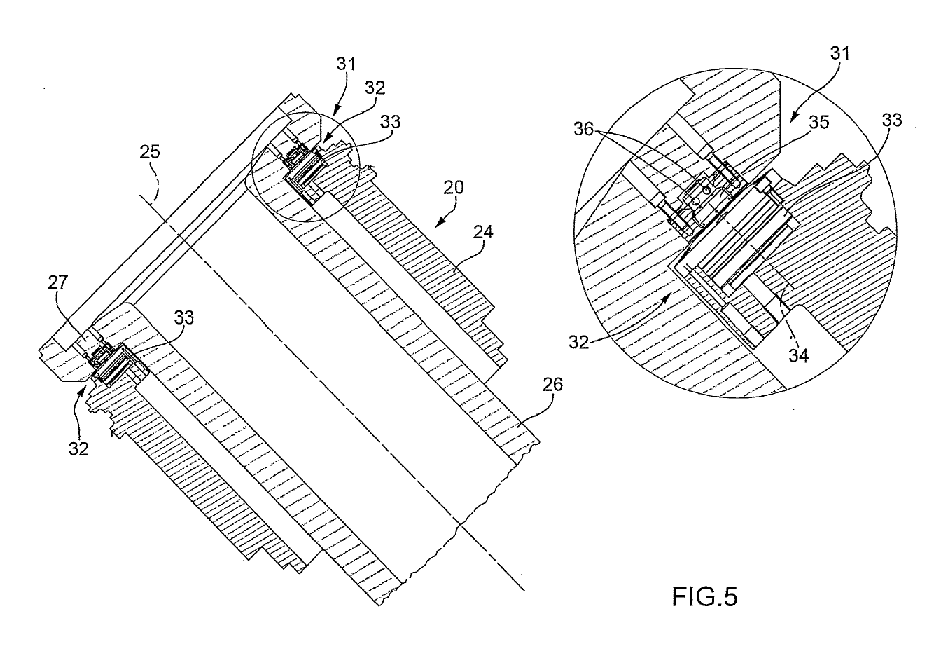

With reference to FIG. 5, the slide 26 is suitable to be locked against the tube 24 in the direction 4 by means of a locking assembly 31 comprising a plurality of locking devices 32 (in this case four locking devices 32) uniformly distributed about the axis 25.

Each device 32 includes an actuating cylinder 33, which is housed inside the tube 24, has a longitudinal axis 34 parallel to the direction 4, and is provided with an output shaft 35 which extends in the direction 4, protrudes axially outside the tube 24, and is provided with a plurality of hooking members 36 uniformly distributed about said axis 34.

Each member 36 is housed inside a relative radial seat (not shown) made through the rod 35 and shaped in such a way as to allow the member 36 to move crosswise with respect to the axis 34 between a clamping position and a released position of the slide 26.

When the slide 26 is arranged in a retracted position with the flange 27 substantially in contact with the tube 24 (FIG. 5), the rods 35 of the cylinders 33 extend within the flange 27, the members 36 are moved to their clamping positions and the rods 35 are moved to relative retracted positions to lock the slide 26 against the tube 24.

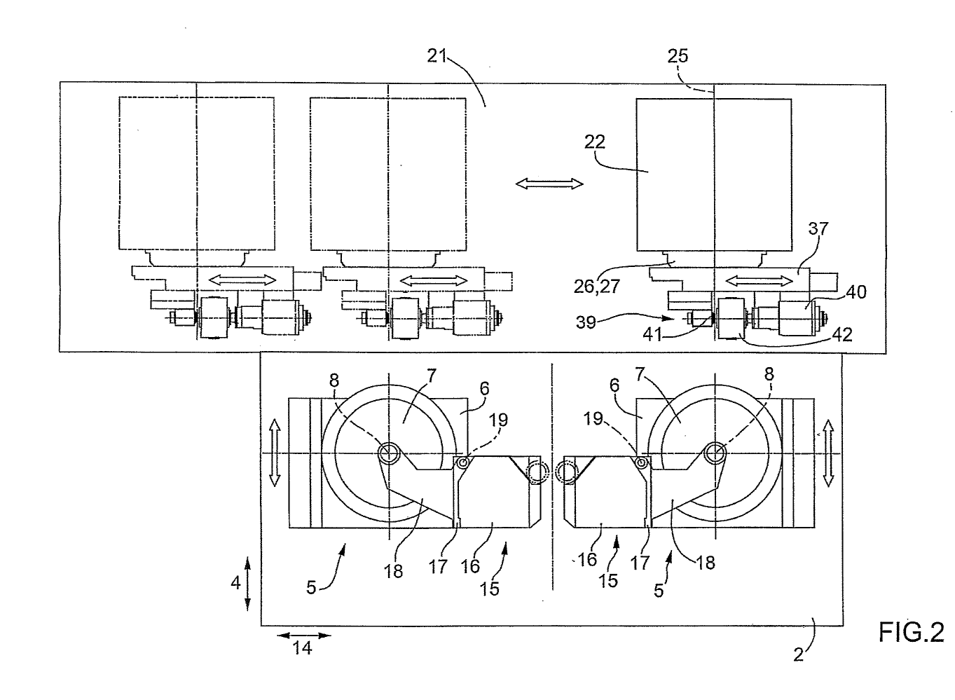

With reference to FIG. 2, the unit 20 also comprises a slide 37 slidingly coupled to the flange 27, so as to move, in relation to the slide 26 and under the thrust of a known and not shown actuating device, in a straight line in a direction 38, the orientation of which depends on the angular position of the tube 24 about the axis 25.

The slide 37 supports an operating head 39 comprising an electric motor 40, which extends in the direction 38, and has an output shaft 41 to which at least one tool 42 is keyed for machining said pieces (not shown).

During use, the operating head 39 is moved along the base 21 in the direction 14 between two machining stations, inside each of which the head 39 faces a clamping unit 5 to machine the piece (not shown) mounted on the relative faceplate 7, and a tool changing station, in which the head 39 fits into the portion of the base 21 that protrudes from the frame 2 in the direction 14 to replace the tool 42.

The machine 1 is capable of performing two types of machining processes on each piece (not shown):

gear cutting, to produce the teeth of the gears (not shown), which normally comprises a first rough-machining stage and a second finishing phase, and

a grinding process to grind the teeth made during the previous gear cutting process and which normally also comprises a first rough-grinding stage and a second finishing phase.

In this respect it should be noted that the locking assembly 31 of the slide 26 and the locking device 10 for each slide 6 are connected to an electronic control unit (not shown) capable of selectively moving the locking assembly 31 into its locking position and the locking device 10 into its released position when machining the teeth on the relative piece (not shown) and capable of selectively moving the locking assembly 31 in its released position and the locking device 10 in its locked position while said piece (not shown) is being ground. In other words, gear cutting is performed by moving only the faceplate 7 in the direction 4 and locking the operating head 39 in said direction 4, while the grinding process is performed by moving only the operating head 39 in the direction 4 and locking the faceplate 7 in said direction 4.

Locking the slide 26 in the direction 4 prevents the high levels of stress transmitted to the operating head 39 during gear machining to jeopardize the proper orientation and correct shape of the guideways 24a of the tube 24 and thus allows the machine 1 to perform both the gear cutting process and the grinding process properly on each piece (not shown) using a single operating head 39.

According to alternative not shown embodiments, the operating head 39 and/or the slides 6 may clearly be mounted on a combination of slides and rotating support units other than those described above.

1. A machine for making gears, the machine comprising at least one faceplate (7), which is mounted so as to rotate about a given longitudinal first axis (8) thereof, and supports a piece being machined; and at least one operating head (39), which is provided with at least one tool (42) for the machining of the piece, and is movable in a first direction (4) substantially transversal to said first axis (8); and being characterized in that the faceplate (7) is movable in said first direction (4); a first and a second locking device (31, 10) being suitable to selectively lock the operating head (39) and the faceplate (7) in the first direction (4) respectively.

2. The machine according to claim 1, further comprising an electronic control unit for moving the first locking device (31) in a locked position and the second locking device (10) in an unlocked position when a first tool (42) for the toothing of the piece is mounted on the operating head (39) and for moving the first locking device (31) in an unlocked position and the second locking device (10) in a locked position when a second tool (42) for the grinding of the piece is mounted on the operating head (39).

3. The machine according to claim 1, further comprising a first guiding device (24), which extends in said first direction (4), and is slidingly engaged by the operating head (39); the first locking device (31) comprising first locking means (32) movable between a locked position of the operating head (39) along the first guiding device (24) and an unlocked position.

4. The machine according to claim 3, wherein the first locking means (32) comprise at least one tie rod (35), which extends in the first direction (4), and is carried by the first guiding device (24) for locking the operating head (39) on the first guiding device (24).

5. The machine according to claim 4, wherein the tie rod (35) has a second longitudinal axis (34) parallel to the first direction (4), and is provided with a plurality of hooking members (36), which are distributed about said second axis (34), and are movable between an extracted locking position of the operating head (39) and a retracted released position of the operating head (39).

6. A machine according to claim 4, wherein the tie rod (35) is movable in the first direction (4).

7. The machine according to claim 1, further comprising a second guiding device (3, 12), which extends in said first direction (4), and is slidingly engaged by the faceplate (7); the second locking device (10) comprising second locking means (11) movable between a locked position of the faceplate (7) along the second guiding device (3, 12) and an unlocked position.

8. The machine according to claim 7, wherein the second locking means (11) comprise a brake (11) carried by the faceplate (7) for locking the faceplate (7) along the second guiding device (3, 12).

9. The machine according to claim 8, wherein the brake (11) comprises at least one braking shoe (13) movable between a clamping position and a released position of the second guiding device (3, 12).

10. The machine according to claim 1, further comprising an operating unit (20) comprising, in turn, an elongated base (21) extending in a second direction (14) substantially transversal to the first direction (4), a first slide (22) mounted on the base (21) to move in the second direction (14), a second slide (23) mounted on the first slide (22) to move in a third direction (9) substantially orthogonal to said first and second direction (4, 14), a first guiding device (24) mounted rotatably on the second slide (23) for rotating about a third longitudinal axis (25) thereof parallel to said first direction (4), and a third slide (26) mounted on the first guiding device (24) to move in the first direction (4); the operating head (39) being carried by said third slide (26).
